(19) United States
(12) Patent Application Publication
(10) Pub. No.: US 2008/0264376 A1
(43) Pub. Date: Oct. 30, 2008

(54) Piston for an internal combustion engine

(75) Inventors: Ralf Braig, Schorndorf (DE); Rainer Fischer, Stuttgart (DE); Peter Kemnitz, Leutenbach (DE); Peter Kleinle, Freiberg (DE)

Correspondence Address: COLLARD & ROE, P.C., 1077 NORTHERN BOULEVARD, ROSLYN, NY, 11576, US

(73) Assignee: MAHLE International GmbH

(21) Appl. No.: 12/008,747

(22) Filed: Jan. 14, 2008

(30) Foreign Application Priority Data
Apr. 27, 2007 (DE) 10 2007 020 447.9

(51) Int. Cl. F02F 3/00

(52) U.S. Cl. 123/193.6; 123/193.4

(57) ABSTRACT

A piston for an internal combustion engine has a piston crown, a circumferential top land, and a circumferential ring belt having ring grooves, as well as having a piston skirt that has two skirt walls disposed on the major thrust side and the minor thrust side of the piston, and two box walls, set back with regard to the ring belt, that connect the skirt walls. The box walls have pin bosses with pin bores. The skirt wall disposed on the major thrust side is shorter, in a circumference direction of the piston, than the skirt wall disposed on the minor thrust side.

### BACKGROUND OF THE INVENTION

1. Field of the Invention

The present invention relates to a piston for an internal combustion engine, having a piston crown, a top land, and a circumferential ring belt having ring grooves. The piston has a piston skirt that has two skirt walls, disposed on the major thrust side and the minor thrust side of the piston, and two box walls, set back with regard to the ring belt, that connect the skirt walls. The box walls are provided with pin bosses having pin bores.

2. The Prior Art

A piston of the type stated above is known under the designation MAHLE Ecoform®. Pistons having this construction are also referred to as box-type pistons. With typical box-type pistons, two walls of the piston skirt are set back with regard to the outer contour of the piston. The two walls that are set back and are slightly longer are referred to as box walls, and the two other walls, which are somewhat narrower and not set back, are the skirt walls, and have the actual working surface of the piston skirt. The pin bosses with the pin bores are integrated into the box walls. The box walls and the pin bosses are connected with the piston crown on the underside of the piston crown.

In the case of such pistons, a frequent problem is that the tension that is in effect during operation, in the pin boss region and in the region of the connection of the box walls to the underside of the piston crown, is so great that cracks can occur in the region of the pin bosses and on the underside of the piston crown. These cracks can extend, in an extreme case, through the entire piston crown, and can also affect the skirt walls.

### SUMMARY OF THE INVENTION

It is therefore an object of the invention to reduce these tensions. It is another object of the invention to make a light piston, i.e. to reduce the piston weight and therefore the mass to be moved.

These objects are accomplished by a piston having a skirt wall disposed on the major thrust side that is shorter, in the circumference direction of the piston, than the skirt wall disposed on the minor thrust side.

A differentiation is made between a major thrust side and a minor thrust side because the piston is always pressed or tilted to the side by the connecting rod, which stands at a slant, when the gas pressure that occurs in the combustion chamber acts on the piston crown during ignition, with the result that one of the two skirt walls is pressed against the inner wall of the cylinder bore with its working surface. This skirt wall is referred to as disposed on the major thrust side.

It has now been found in experiments, surprisingly for a person skilled in the art, that with the design according to the invention, hardly any cracks occur any longer in the region of the pin bosses, i.e. in the region of the supports of the box walls on the underside of the piston crown.

In one embodiment of the invention, the distance between those box wall sections that connect the pin bosses with the skirt wall disposed on the minor thrust side is less in the region of the pin bosses than in the region of the skirt wall. In this regard, the connection of the box wall sections to the skirt wall disposed on the minor thrust side can be configured to be arc-shaped, straight, S-shaped, U-shaped, convex, or concave. With this advantageous embodiment, the risk of crack formations in the box walls, and possibly in the skirt walls, is further reduced.

In contrast, it is advantageous if the distance between those box wall sections that connect the pin bosses with the skirt wall disposed on the major thrust side, in the region of the pin bosses, is equal to or greater than that in the region of the skirt wall. This means that the box wall sections in question either run parallel to one another from the pin bosses to the skirt wall, or run towards one another. In this way, again, the risk of crack formations in the box walls, and possibly in the skirt walls, is further reduced.

The skirt wall disposed on the major thrust side can be configured to be thinner in its center region than in its edge regions that face the box walls. This can go so far, for example, that the skirt wall disposed on the major thrust side is configured to be up to 50% thinner in its center region than in its edge regions assigned to the box walls. In this way, significant weight savings are achieved, thereby bringing about a significant reduction of the moved mass of the piston according to the invention.

It is particularly advantageous if the increase in thickness of the skirt wall, from its center region to its outer regions, proceeds at a constant rate. In this way, the tension stresses are uniformly distributed over the skirt wall.

At least the skirt wall disposed on the major thrust side can have a greater curvature, at least in the region of its outer mantle surface, than the ring belt, i.e. it can have a greater ovality than the ring belt. With this measure, as well, the elasticity of the piston according to the invention can be increased in the region of the piston skirt.

In one embodiment, the box walls run at a distance from one another, in the region of their connection to the underside of the piston crown, that approximately corresponds to the distance between the inner pin boss edges in the boss zenith. Experiments in this regard have shown that the structural rigidity of the piston according to the invention is further improved this way.

Furthermore, the box walls can enclose an acute angle in the direction of their connection to the underside of the piston crown. Preferably, each box wall forms an angle of 5° to 30° with the longitudinal axis of the piston. In this way, a greater volume of the upcasting can be achieved, i.e. larger cores can be used in the casting mold for the piston according to the invention than before, which cores extend particularly far in the direction of the underside of the piston crown. This has the effect that the piston crown of the piston according to the invention can be configured to be clearly thinner than before. In this way, a significant weight reduction can be achieved, for example by up to 10% to 15% as compared to the state of the art. Finally, the thickness of the box walls 18, 19 can be additionally reduced, as compared with the pistons known from the state of the art, by up to 100%, thereby bringing about another very significant weight saving.

A particularly preferred embodiment of the piston according to the invention provides that the box walls have a uniform wall thickness, or one that constantly increases downward—in the direction of the oil chamber. Furthermore, the box walls can constantly increase towards the skirt walls. This means that the collar that was usual until now, i.e. the thickened region on the underside of the box walls that was usual until now, is not necessary. In this connection, a more uniform and more harmonious tension distribution was observed both in the box walls and in the skirt walls, under the stress during operation. With this preferred embodiment, the risk of crack formations in the box walls and/or in the skirt walls can therefore be further reduced.

In another preferred embodiment of the piston according to the invention, ribs are provided, which delimit the pin bores laterally, and which extend from the lower region of the ring belt to at least the upper edge of the pin bore. In this way, a particularly advantageous reinforcement of the structure of the piston according to the invention, in the boss region, is achieved, despite the greater elasticity and weight reduction, respectively, that are achieved according to the invention. In this connection, the ribs can extend to the horizontal center axis of the pin bore. The ribs furthermore preferably run in a straight line or in arc shape, so that the formation of steps that could promote a non-uniform tension distribution is avoided. The piston according to the invention can be produced from a light-metal alloy, preferably an aluminum alloy. A MAHLE® alloy based on aluminum, of the type M124, M138, M142, M145 to M174+, for example, is particularly suitable.

The piston according to the invention is particularly suitable for use in diesel engines, which are subject to great stress.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows an embodiment of the piston according to the invention in section along the line I-I in FIG. 2;

FIG. 2 shows the piston according to FIG. 1 in a view in the direction of the arrow P in FIG. 1, tilted by several degrees;

FIG. 3 shows the piston according to FIG. 1 in a side view, onto a skirt wall; and

FIG. 4 shows the piston according to FIG. 1 in section along the line IV-IV in FIG. 2, together with a wall of a cylinder bore, indicated schematically.

### DETAILED DESCRIPTION OF THE PREFERRED EMBODIMENT

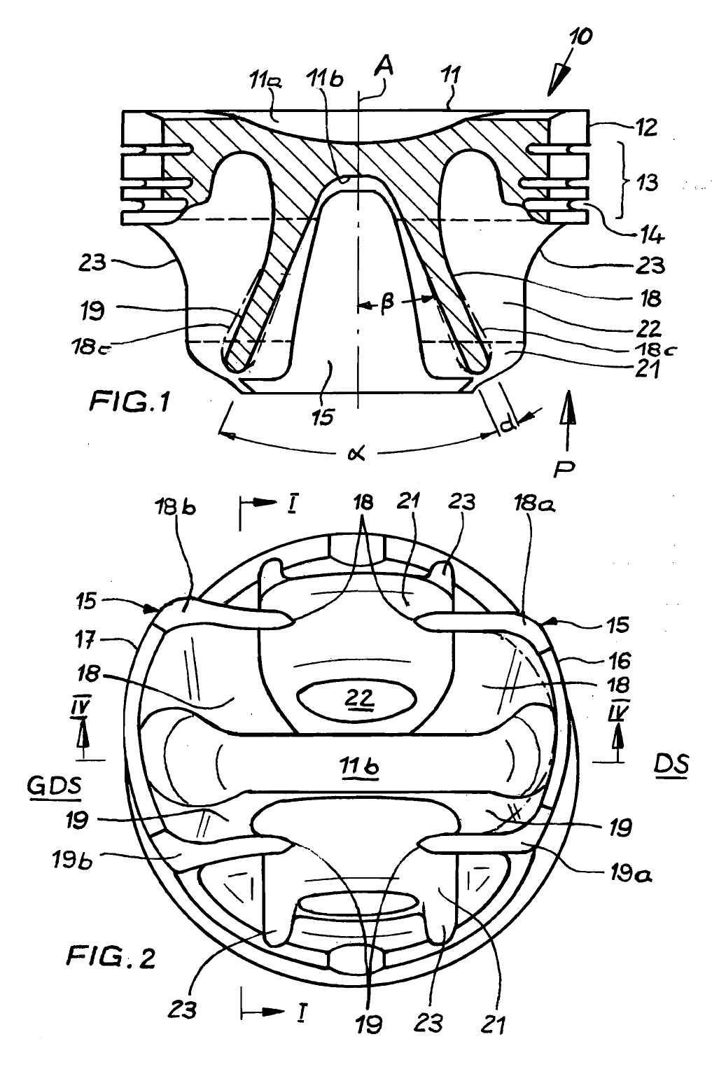

Referring now in detail to the drawings, FIGS. 1 and 2 show an exemplary embodiment of a piston 10 according to the invention, which is particularly suited for use in diesel engines. Piston 10 has a piston crown 11 provided with a combustion bowl 11a, as well as a circumferential top land 12 and a circumferential ring belt 13 with ring grooves 14.

Piston 10 furthermore has a piston skirt 15 that is connected on the underside 11b of piston crown 11. Piston skirt 15 in turn has two skirt walls 16, 17, disposed on the major thrust side (DS) and the minor thrust side (GDS) of piston 10, and two box walls 18, 19 that are set back with regard to ring belt 13, and connect skirt walls 16, 17. The outer circumference surface of each skirt wall 16, 17 represents a working surface of piston skirt 15. Each box wall 18, 19 has a pin boss 21 provided with a pin bore 22. In this way, each box wall 18, 19 is divided into two box wall sections 18a, 18b and 19a, 19b, respectively. In the exemplary embodiment, piston 10 is produced from a MAHLE® alloy based on aluminum, of the type M124, M138, M142, M145 to M174+.

Skirt wall 16 disposed on the major thrust side (DS) is shorter, in the circumference direction of piston 10, than skirt wall 17 disposed on the minor thrust side (GDS). This means that skirt walls 16, 17 are configured asymmetrically. In this way, crack formation, particularly in the region of pin bosses 21 and in the region of piston crown 11, is surprisingly reduced. It was possible to determine this by experiments.

In the exemplary embodiment shown, box wall sections 18a, 19a, which connect pin bosses 21 with skirt wall 16 disposed on the major thrust side (DS), run parallel to one another. However, they can also run towards one another, i.e. the distance between box wall sections 18a, 19a can be greater in the region of pin bosses 21 than in the region of skirt wall 16 (not shown).

Skirt wall 16 can be configured in sickle shape, as indicated with a dot-dash line in FIG. 2. This means that skirt wall 16 is configured to be thinner in cross-section in its center region than in its edge regions, which make a transition into the box wall sections 18a, 19a. This reduction in cross-section can amount to as much as 50%, with reference to the cross-section of the edge regions. In the exemplary embodiment shown, the change in thickness of the skirt wall 16 proceeds constantly from its center region to its edge regions, i.e. there are no steps that might bring about a non-uniform tension distribution in the skirt wall 16.

In the exemplary embodiment shown, box wall sections 18b, 19b, which connect pin bosses 21 with skirt wall 17 disposed on the minor thrust side (GDS), run from pin bosses 21 to skirt wall 17, in approximately trapezoidal shape, towards the outside. The connection of box wall sections 18b, 19b to skirt wall 17 disposed on the minor thrust side (GDS) can be configured in arc shape, as shown in FIG. 2. However, embodiments are also possible in which this connection is configured to be straight, S-shaped, U-shaped, convex, or concave.

From FIG. 2, it is furthermore evident that in the exemplary embodiment shown, box walls 18, 19 run at a distance from one another, in the region of their connection to underside 11b of the piston crown 11, that approximately corresponds to the distance between the inner pin boss edges at the boss zenith. In this way, the structural rigidity of the piston 10 according to the invention is increased, and thus the risk of crack formations is further reduced.

FIG. 1 furthermore shows that the box walls 18, 19 enclose an acute angle (α) in the direction of their connection to the underside 11b of the piston crown 11. In this regard, each box wall 18, 19 can enclose an angle (β) of 5° to 30° with the longitudinal axis (A) of the piston 10, as is evident from FIG. 1. In this way, not only is it possible to achieve a better upcasting, but also, a further reduction in the thickness of the box walls 18, 19 can be achieved, by up to 100% as compared with the pistons known from the state of the art.

Finally, as shown in FIG. 1, box walls 18, 19 have a uniform wall thickness (d) in their lower region, in the direction of their free lower edges. In other words, the collar that was usually required at the lower edges of the box walls 18, 19 until now, in the case of box-type pistons, i.e. a corresponding thickened region, can be eliminated. In this way, not only is a further weight reduction achieved, but also, the tilting moment of piston 10 according to the invention is further reduced. According to another exemplary embodiment, in a broken-line representation according to FIG. 1, box walls 18, 19 can constantly increase, in linear manner, in their wall thickness, starting from approximately the center of the pin bore, all the way to their lower end—in the direction of their free lower edges.

Likewise, box walls 18, 19 that proceed from the piston bosses 21 and lead to the skirt walls 16, 17 can have a wall thickness that constantly increases in linear manner.

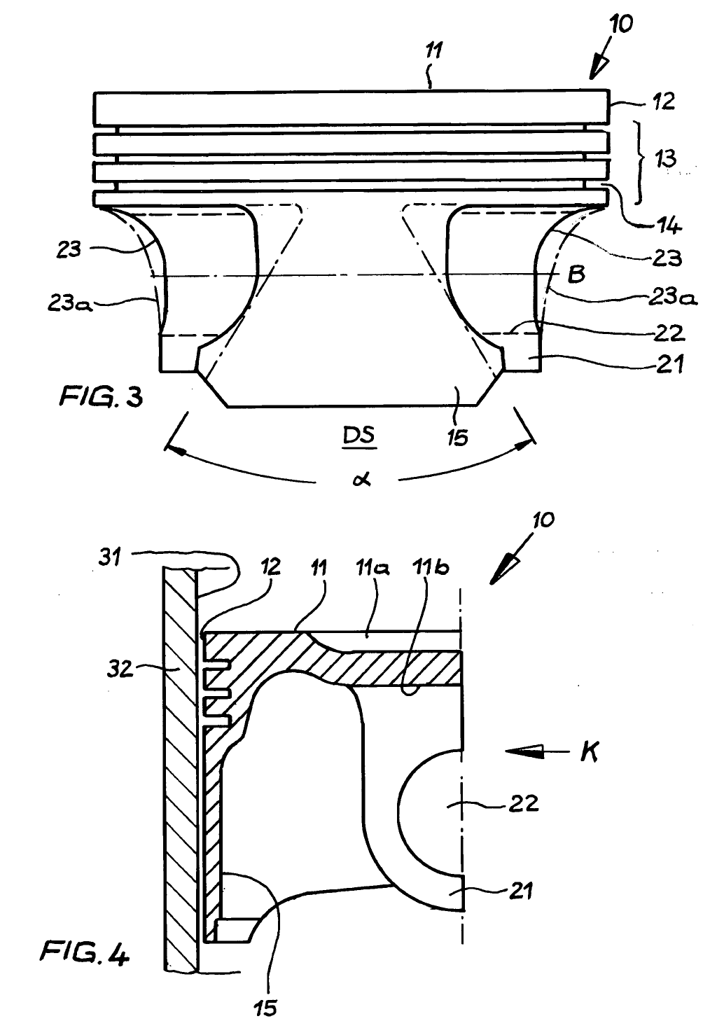

From FIG. 3, it can be seen that ribs 23 are provided on piston 10, which ribs delimit pin bores 22 laterally, and extend from the lower region of ring belt 13, preferably all the way to horizontal center axis B of pin bore 22. From FIG. 3, it is furthermore evident from another exemplary embodiment (broken-line representation) that ribs 23 can also extend to the nadir of pin bores 22. In this way, additional reinforcement of the piston is achieved. Ribs 23 run in arc shape, as can be seen in FIG. 3, but they can also run straight.

FIG. 3 furthermore shows that skirt walls 16, 17 can be configured in different ways, for example with a parallel contour and running out in an arc towards the bottom or in trapezoid shape, as indicated with a broken line.

FIG. 4 shows piston 10 according to the invention in interaction with wall 32 of a cylinder bore 31. The arrow K symbolizes the crosswise force that acts on piston 10 when the gas pressure generated during ignition in the combustion chamber above the piston crown 11 leads to tilting of piston 10. In this connection, it was found, for piston 10 according to the invention, that a clearly thinner box wall thickness can be implemented by means of its structure, which is adapted to stress, and the risk of crack formations, particularly in the region of pin bosses 21, as well as in the region of box walls 18, 19 and skirt walls 16, 17, is clearly reduced. Furthermore, the weight of piston 10 and therefore its moved mass can be decisively reduced, as compared with the state of the art.

Accordingly, while only a few embodiments of the present invention have been shown and described, it is obvious that many changes and modifications may be made thereunto without departing from the spirit and scope of the invention.

What is claimed is:

1. A piston for an internal combustion engine, comprising:
a piston crown having a top land and a circumferential ring belt having ring grooves;
a piston skirt that has two skirt walls disposed one each on a major thrust side (DS) and a minor thrust side (GDS) of the piston, and two box walls that connect the skirt walls and which are set back with respect to the ring belt;
wherein the box walls are provided with pin bosses having pin bores, and
wherein the skirt wall disposed on the major thrust side (DS) is shorter, in a circumference direction of the piston, than the skirt wall disposed on the minor thrust side (GDS).

2. A piston according to claim 1, wherein a distance between the box wall sections that connect the pin bosses with the skirt wall disposed on the minor thrust side (GDS) is less in a region of the pin bosses than in a region of the skirt wall.

3. A piston according to claim 1, wherein a connection of the box wall sections to the skirt wall disposed on the minor thrust side is configured to be arc-shaped, straight, S-shaped, U-shaped, convex, or concave.

4. A piston according to claim 1, wherein a distance between those box wall sections that connect the pin bosses with the skirt wall disposed on the major thrust side (DS) is equal to or greater in a region of the pin bosses than in a region of the skirt wall.

5. A piston according to claim 1, wherein the skirt wall disposed on the major thrust side (DS) is configured to be thinner in a center region than in edge regions that face the box walls.

6. A piston according to claim 5, wherein the skirt wall disposed on the major thrust side (DS) is configured to be up to 50% thinner in the center region than in the edge regions assigned to the box walls.

7. A piston according to claim 5, wherein the skirt wall increases in thickness from the center region to the edges at a constant rate.

8. A piston according to claim 1, wherein at least the skirt wall disposed on the major thrust side (DS) has a greater curvature, at least in a region of its outer mantle surface, than a curvature of the ring belt.

9. A piston according to claim 1, wherein the box walls run at a distance from one another, in a region of their connection to an underside of the piston crown, said distance approximately corresponding to a distance between inner pin boss edges in a boss zenith.

10. A piston according to claim 1, wherein the box walls enclose an acute angle (α) in a direction of their connection to an underside of the piston crown.

11. A piston according to claim 10, wherein each box wall forms an angle (β) of 5° to 30° with longitudinal axis (A) of the piston.

12. A piston according to claim 1, wherein the box walls have a uniform wall thickness (d) in a lower region, in a direction of their free lower edges, or wherein the wall thickness of the box walls increases constantly, in a linear manner, in a direction of the free lower edges.

13. A piston according to claim 1, wherein the box walls that proceed from the piston bosses and lead to the skirt walls have an increasing wall thickness.

14. A piston according to claim 1, further comprising ribs that delimit the pin bores laterally, and which extend from a lower region of the ring belt to at least a horizontal center axis (B) of the pin bore.

15. A piston according to claim 14, wherein the ribs extend to a nadir of the pin bore.

16. A piston according to claim 14, wherein the ribs run straight or in arc shape.

17. A piston according to claim 1, wherein the piston is produced from an aluminum alloy.

18. A piston according to claim 1, wherein the piston is for a diesel engine.
